(19) United States
(12) Patent Application Publication
(10) Pub. No.: US 2016/0238145 A1
(43) Pub. Date: Aug. 18, 2016

(54) SHUTOFF VALVE IN BACKFLOW PREVENTION DEVICE WITH VISUAL INDICATOR

(71) Applicant: Douglas H. Powell, Eldorado Hills, CA (US)

(72) Inventor: Douglas H. Powell, Eldorado Hills, CA (US)

(21) Appl. No.: 14/622,316

(22) Filed: Feb. 13, 2015

(51) Int. Cl. F16K 15/00; F16K 31/60; F16K 37/00; F16K 1/22

(52) U.S. Cl. CPC F16K 15/00; F16K 1/22; F16K 31/602; F16K 37/00

(57) ABSTRACT

A backflow prevention device. The backflow prevention device includes a housing defining a water flow stream. The housing includes an inlet configured to connect to a water supply and an outlet configured to connect to a system that uses water. The backflow prevention device also includes an upstream butterfly valve configured to allow a user to control the water flow stream through the housing and an upstream indicator post. The upstream indicator post is substantially parallel to the water flow if the upstream butterfly valve is closed and is substantially perpendicular to the water flow if the upstream butterfly valve is open. The backflow prevention device further includes a downstream butterfly valve configured to allow a user to control the water flow stream through the housing and a downstream indicator post.

### CROSS-REFERENCE TO RELATED APPLICATIONS

Not applicable.

### BACKGROUND OF THE INVENTION

Shutoff valves are widely used in backflow prevention applications where isolation of the backflow preventer, from the main water supply pressure, is required in order to properly test the functionality of the backflow preventer. Shutoff valves currently used in backflow prevention applications have limitations. Smaller backflow prevention applications tend to use ball valves. Small ball valves are cheap and flow control is simple. I.e., a 90 degree handle rotation changes the ball valve from open to closed and vice versa. In addition, the handle of the ball valve presents an easy visual indicator as to whether the valve is open or closed. However, ball valves get far more expensive as they get larger. Therefore, they are impractical for use as a shutoff valve in large backflow prevention applications.

For larger backflow prevention applications typically a gate valves are used. A gate valve is a valve that opens by moving a shut off wedge in and out of the fluid path opening or closing the valve. Gate valves require a high number of rotations of a handle or other mechanism for a user to change the gate valve from an open state to a closed state. This allows the gate valve to open and close slowly in order to avoid water hammer. Partial rotation of the gate valve handle allows the user to control partial flow through the valve for moderate user control of fluid flow.

However, it is extremely difficult to look at a Non Rising Stem (NRS) gate valve and determine immediately whether the valve is open or closed. Therefore, to allow for a visual indicator, a moving stem is added to the middle of the gate valve handle. This type of gate valve is called an Outside Stem and Yoke (OS&Y) gate valve. As the handle is twisted counterclockwise, the stem raises giving a visual indicator that the gate valve is open. As the handle is twisted clockwise, the stem lowers giving a visual indicator that the gate valve is closed.

Further, most gate valves have a top cover inclosing the chamber in which the shut off wedge functions. This top cover allows for the maintenance and replacement of the shut off wedge without have to remove the valve from the main water line. Since most shut off wedges are elastomeric they wear out over time, making it necessary to replace the shut off wedge at times.

To review the OSY gate valve is preferred in many applications associated with backflow prevention because it has a stem for visual indication of opened and closed and the shut off wedge is accessible for maintenance. However the many components, including; stem, yoke, cover, handle and wedge chamber require a very large and therefor very expensive valve.

Occasionally, a butterfly valve is used as a shutoff valve in backflow prevention applications, because it has the simplicity of a quarter turn ball valve without the large size, weight and cost of gate valve. However, it is difficult to visually inspect the open or closed state of a butterfly from a distance. A flag may be added to the butterfly valve to allow a user to determine if the valve is opened or closed but typically the user must be quite close to the valve to make the determination. Therefore, regulations and/or traditions may restrict the use of butterfly valves when frequent inspection of the shutoff valve is required.

Accordingly, there is a need in the art for a shutoff valve that includes an easy visual indicator as to whether the shutoff valve is open or closed even when view from a distance.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a backflow prevention device. The backflow prevention device includes a housing defining a water flow stream. The housing includes an inlet configured to connect to a water supply and an outlet configured to connect to a system that uses water. The backflow prevention device also includes an upstream butterfly valve configured to allow a user to control the water flow stream through the housing and an upstream indicator post. The upstream indicator post is substantially parallel to the water flow if the upstream butterfly valve is closed and is substantially perpendicular to the water flow if the upstream butterfly valve is open. The backflow prevention device further includes a downstream butterfly valve configured to allow a user to control the water flow stream through the housing and a downstream indicator post. The downstream indicator post is substantially parallel to the water flow if the downstream butterfly valve is closed and is substantially perpendicular to the water flow if the downstream butterfly valve is open. The backflow prevention device additionally includes a pair of check modules located between the upstream butterfly valve and downstream butterfly valve.

Another example embodiment includes a backflow prevention device, configured such that the flow stream is oriented approximately horizontally. The backflow prevention device includes a housing defining a water flow stream. The housing includes an inlet configured to connect to a water supply and an outlet configured to connect to a system that uses water. The backflow prevention device also includes an upstream butterfly valve configured to allow a user to control the water flow stream through the housing and an upstream indicator post. The upstream indicator post is approximately horizontal if the upstream butterfly valve is closed and is approximately vertical if the upstream butterfly valve is open. The backflow prevention device further includes a downstream butterfly valve configured to allow a user to control the water flow stream through the housing and a downstream indicator post. The downstream indicator post is approximately horizontal if the downstream butterfly valve is closed and is approximately vertical if the downstream butterfly valve is open. The backflow prevention device additionally includes a pair of check modules located between the upstream butterfly valve and downstream butterfly valve.

Another example embodiment includes a backflow prevention device, configured such that the flow stream is oriented approximately horizontally. The backflow prevention device includes a housing defining a water flow stream. The housing includes an inlet connected to a water supply and an outlet connected to a system that uses water. The backflow prevention device also includes an upstream butterfly valve configured to allow a user to control the water flow stream through the housing. The upstream butterfly valve includes a disk, where the disk is configured to prevent water flow at a first position, allow water flow at a second position and rotate about an axis of rotation between the first position and the second position. The disk includes a seal, where the seal is configured to sealingly engage a sealing surface in the housing at the first position. The backflow prevention device further includes an upstream indicator post. The upstream indicator post is approximately horizontal if the upstream butterfly valve is closed and is approximately vertical if the upstream butterfly valve is open. The backflow prevention device additional includes a downstream butterfly valve configured to allow a user to control the water flow stream through the housing. The downstream butterfly valve includes a disk, where the disk is configured to prevent water flow at a first position, allow water flow at a second position and rotate about an axis of rotation between the first position and the second position. The disk includes a seal, where the seal is configured to sealingly engage a sealing surface in the housing at the first position. The backflow prevention device moreover includes a downstream indicator post. The downstream indicator post is approximately horizontal if the downstream butterfly valve is closed and is approximately vertical if the downstream butterfly valve is open. The backflow prevention device additionally includes an access port in the housing configured to provide a user with access to the upstream butterfly valve disk and the downstream butterfly valve disk. The backflow prevention device further includes a pair of check modules located between the upstream butterfly valve and downstream butterfly valve.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of the example of a backflow prevention device in which the shutoff valves are in the closed position;

FIG. 1B illustrates a side view of the example of a backflow prevention device in which the shutoff valves are in the open position;

FIG. 1C illustrates an isometric view of the example of a backflow prevention device in which the shutoff valves are in the closed position;

FIG. 1D illustrates an isometric view of the example of a backflow prevention device in which the shutoff valves are in the open position;

FIG. 1E illustrates an isometric view of a partial cutaway of the example of a backflow prevention device in the open position;

FIG. 2A illustrates an example of the flow indicator in the closed position;

FIG. 2B illustrates an example of the flow indicator in the open position;

FIG. 3A illustrates an exploded top perspective view of the opening or access port of a backflow prevention device;

FIG. 3B illustrates a top view of the opening or access port of a backflow prevention device without the cover; and

FIG. 4 illustrates an example of a butterfly valve.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

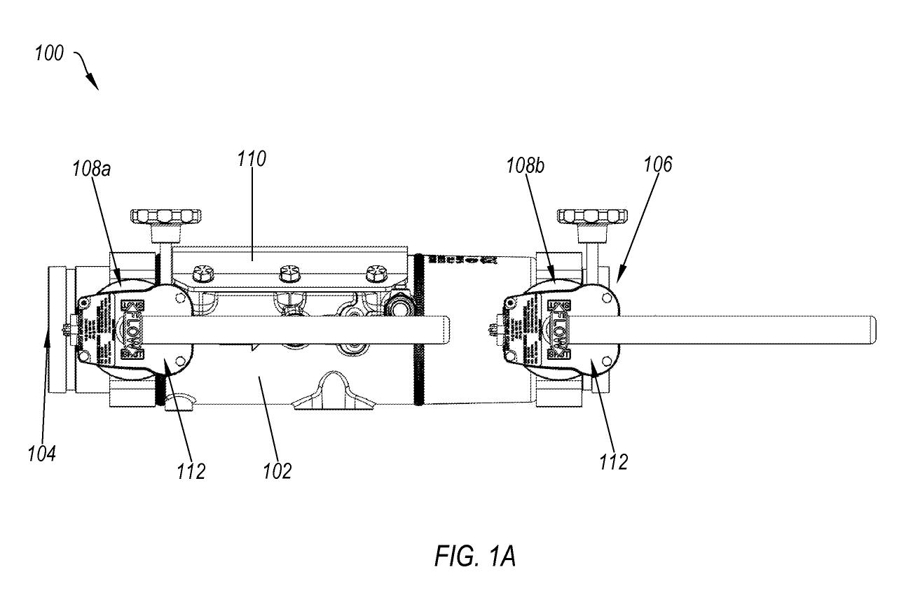

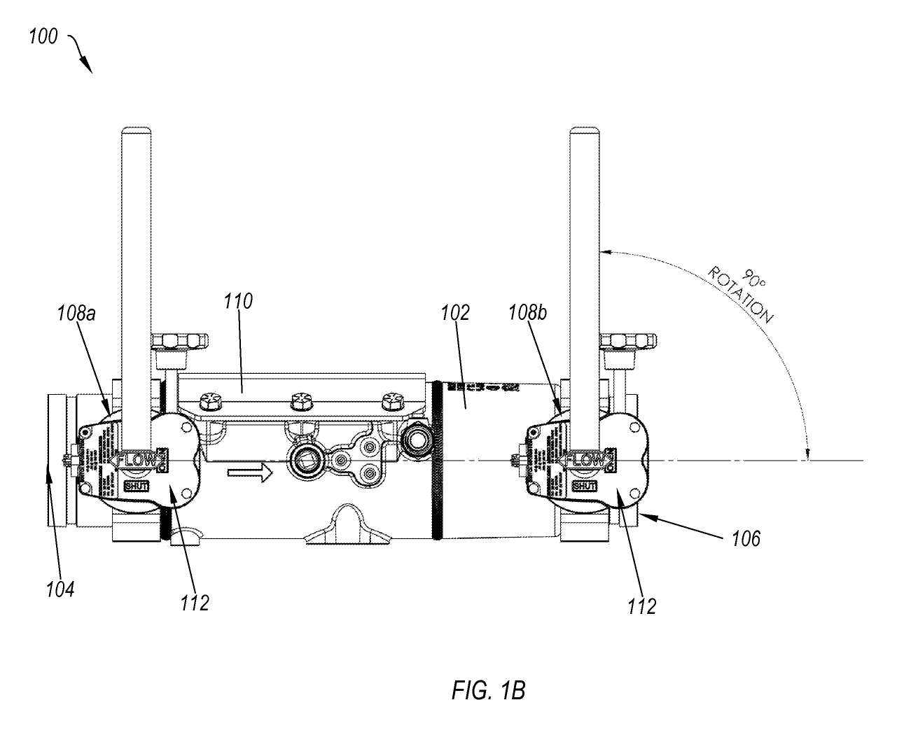

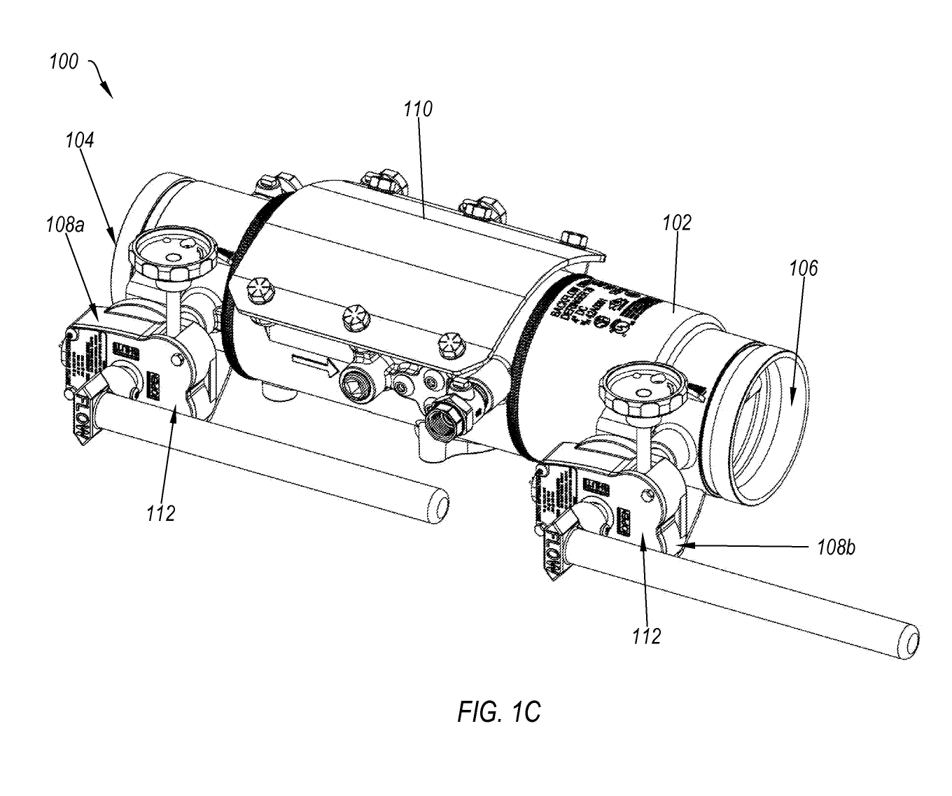

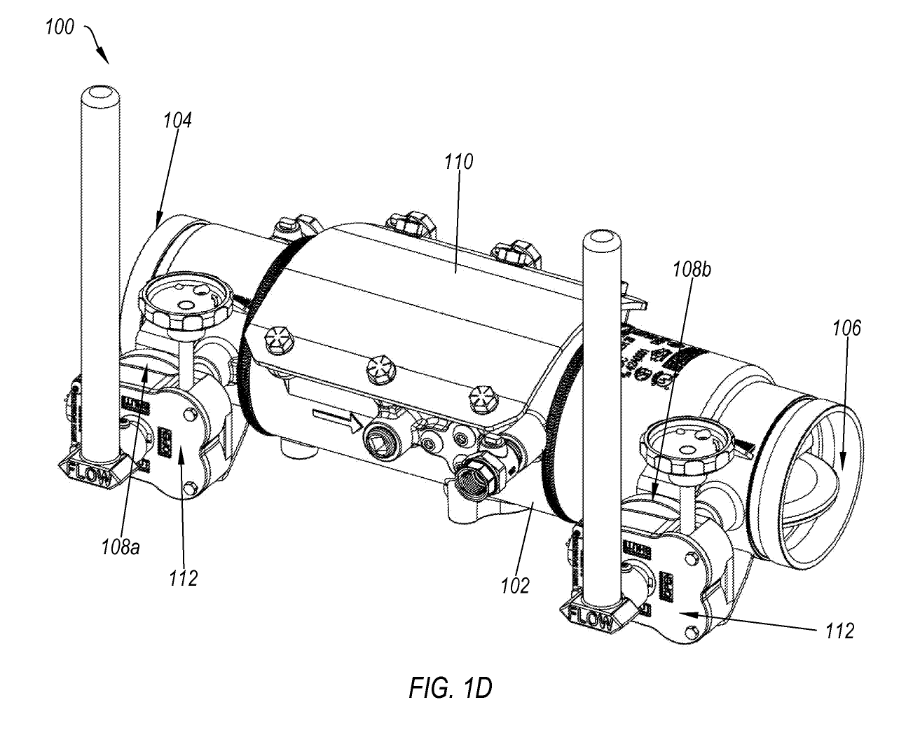

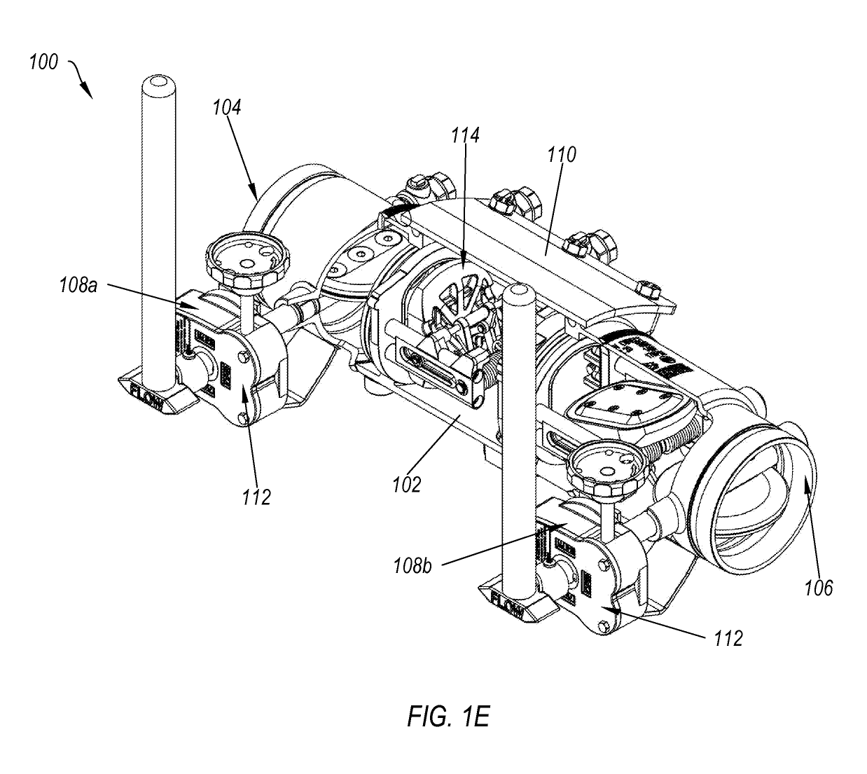

FIGS. 1A, 1B, 1C, 1D and 1E (collectively “FIG. 1”) illustrate an example of a backflow prevention device 100. FIG. 1A illustrates a side view of the example of a backflow prevention device 100 in the closed position; FIG. 1B illustrates a side view of the example of a backflow prevention device 100 in the open position; FIG. 1C illustrates an isometric view of the example of a backflow prevention device 100 in the closed position; FIG. 1D illustrates an isometric view of the example of a backflow prevention device 100 in the open position; and FIG. 1E illustrates an isometric view of a partial cutaway of the example of a backflow prevention device 100 in the open position. The upstream and downstream butterfly valves of the backflow prevention device 100 allows for an entire water supply to be turned on or turned off at a single location. For example, the upstream and downstream butterfly valves of the backflow prevention device 100 can be used to control the water supply of a building, of a city region, etc. The backflow prevention device 100 can, therefore, allow a worker to shut a single valve (or series of valves) to eliminate water flow if an emergency occurs.

FIG. 1 shows that the backflow prevention device 100 can include a housing 102. The housing 102 is configured to contain the water flow within the backflow prevention device 100. I.e., the housing 102 must be of sufficient strength to ensure that the backflow prevention device 100 can withstand the pressure of the water supply. Additionally or alternatively, the housing 102 is configured to align the other components of the backflow prevention device 100. Such other components include an upstream butterfly valve, a downstream butterfly valve and a pair of check valve modules, as described below. I.e., the housing 102 can allow the internal and external components of the backflow prevention device 100 to be installed and proper spacing to be maintained among the components. The housing 102 can include a single component or an assembly of more than one component. I.e., the housing 102 can include a single structure or can include multiple structures attached to one another.

FIG. 1 also shows that the backflow prevention device 100 can include an inlet 104. The inlet 104 is configured to receive a water supply. I.e., the inlet 104 can be connected to a water supply and receive the water flow. In particular, the inlet 104 can include one or more coupling mechanisms which allow the backflow prevention device 100 to be connected to pipes, hoses or other devices which are configured to supply water. For example, the inlet 104 can include threading, grooves, flanges or other structures which allow attachment to the water supply.

FIG. 1 further shows that the backflow prevention device 100 can include an outlet 106. The outlet 106 is configured to output water. I.e., the outlet 106 can be connected, either directly or indirectly, as a water supply to a building or system that uses water. In particular, the outlet 106 can include one or more coupling mechanisms which allow the backflow prevention device 100 to be connected to pipes, hoses or other devices which are configured to receive water. For example, the outlet 106 can include threading, grooves, flanges or other structures which allow attachment to the water output. After the water passes the outlet 106 the water flow can be divided as necessary.

FIG. 1 additionally shows that the backflow prevention device 100 can include an upstream butterfly valve 108a and a downstream butterfly valve 108b (collectively “butterfly valves 108”). The butterfly valves 108 can be used to control or regulate water flow through the backflow prevention device 100. I.e., a user can close the upstream butterfly valve 108a, the downstream butterfly valve 108b or both as needed to control water flow. For example, closure of the upstream and downstream butterfly valves 108a can allow maintenance of the check valve modules of the backflow prevention device 100. Additionally or alternatively, shutoff of the downstream butterfly valve can allow a user to shutoff water supply to the pipe, hose or other device connected to the outlet 106 and, therefore, any building or structure receiving the water supply. The butterfly valves 108 offer a cost advantage over the use of gate valves or ball valve.

FIG. 1 also shows that the backflow prevention device 100 can include a cover 110. The cover 110 can be configured to close an access port in the housing 102. In particular, the cover 110 can be removed to allow maintenance or replacement of components within the housing 102 including the check valve modules. I.e., a user can remove the cover 110 to access portions of the butterfly valves 108.

FIG. 1 further shows that the backflow prevention device 100 can include a flow indicator 112. The flow indicator 112 is an easily identifiable device for allowing a user to see whether the water is flowing through the housing or whether the water flow is currently shutoff. I.e., a user can inspect whether water is flowing through the backflow prevention device 100 from a distance. For example, an inspector could drive by an outdoor backflow prevention device 100 and visibly inspect the water flow without ever leaving the vehicle.

FIG. 1 additionally shows that the backflow prevention device 100 can include an upstream check valve module 114a and a downstream check valve module 114b (collectively “check valve modules 114”). The check valve modules 114 can prevent reverse flow within the backflow prevention device 100. I.e., the check valve modules 114 can be configured to allow water to flow in a forward direction (left to right as shown in FIG. 1E) and prevent water flow in the reverse direction (right to left as shown in FIG. 1E).

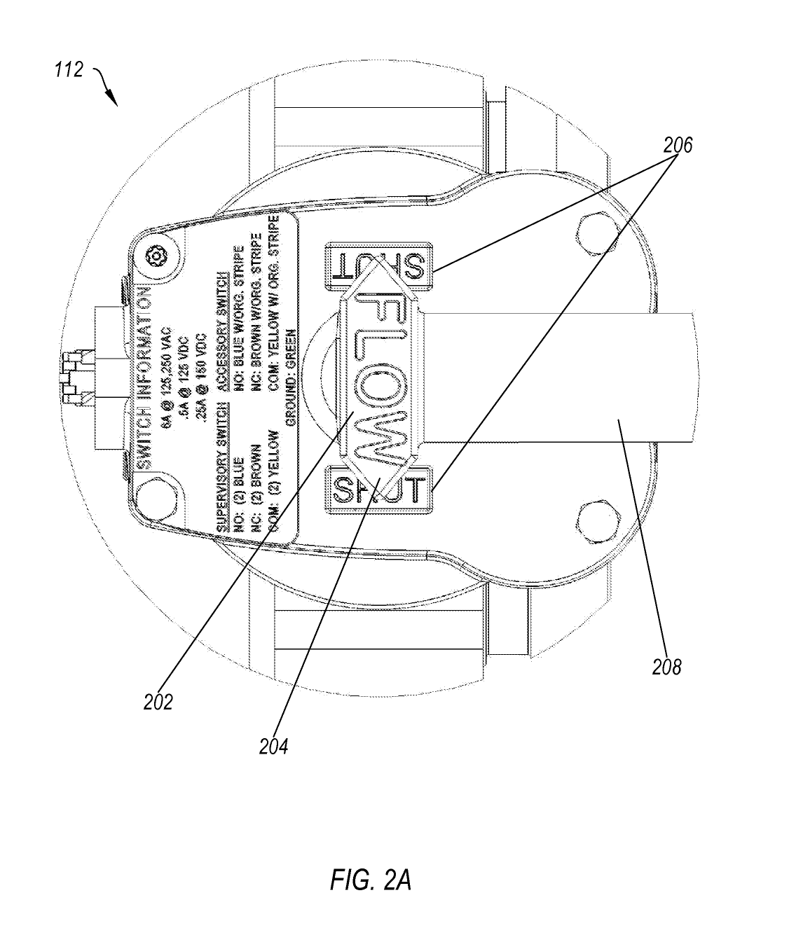

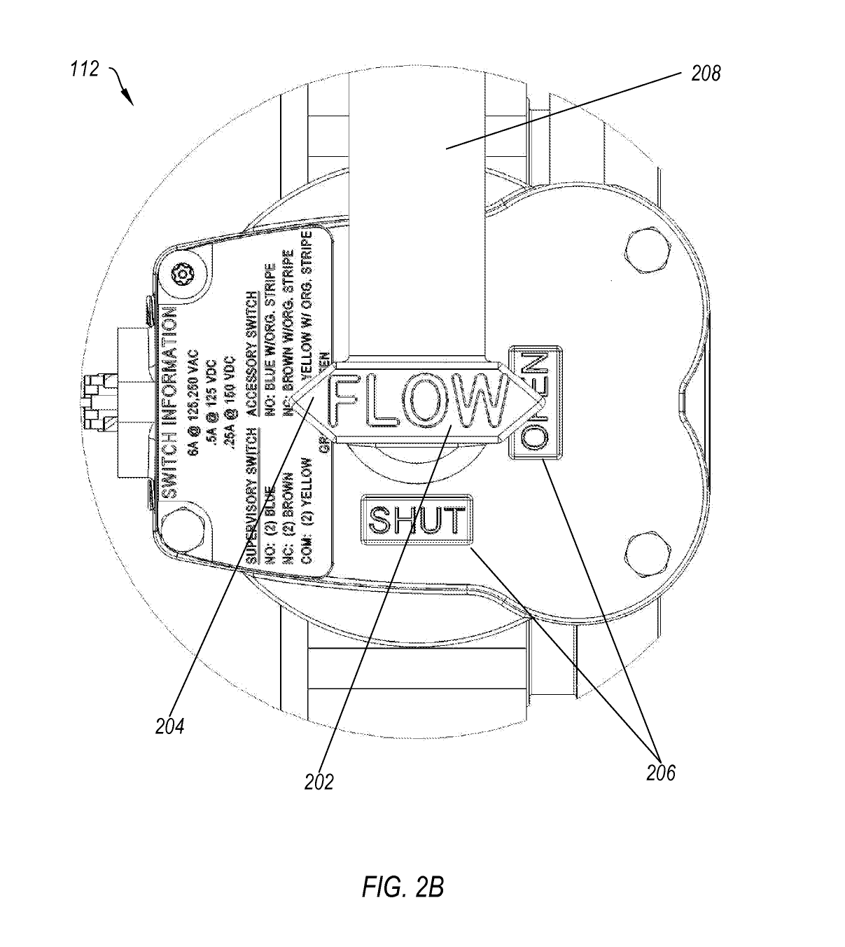

FIGS. 2A and 2B (collectively “FIG. 2”) illustrate an example of a flow indicator 112. FIG. 2A illustrates an example of the flow indicator 112 in the closed position; and FIG. 2B illustrates an example of the flow indicator 112 in the open position. The flow indicator 112 provides a visual identification of the flow status of a shutoff valve. In particular, the flow indicator allows a user to visually inspect whether flow is occurring or has been shut off.

FIG. 2 shows that the flow indicator 112 can include a flow display 202. The flow display 202 shows the current flow direction of water within the shutoff valve. I.e., if the flow display 202 is substantially parallel (within 10 degrees of parallel) to the direction of water flow (i.e., approximately horizontal—within 10 degrees of horizontal—when installed in a horizontally installed backflow prevention device) through the shutoff valve then water is currently flowing (i.e., the shutoff valve is open). However, if the flow display 202 is substantially perpendicular (within 10 degrees of perpendicular) to the direction of water flow (i.e., approximately vertical—within 10 degrees of vertical—when installed in a horizontally installed backflow prevention device) through the shutoff valve then water is currently not flowing (i.e., the shutoff valve is closed).

FIG. 2 also shows that the flow display 202 can include a pointer 204. The pointer 204 points in the direction that water may currently flow. I.e., the pointer 204 can include an arrow which points the direction in which water will flow. Thus, a user can quickly ascertain whether water is currently flowing (pointer is substantially parallel to the direction of water flow through the shutoff valve) or currently not flowing (pointer is substantially perpendicular to the direction of water flow through the shutoff valve).

FIG. 2 further shows that the flow indicator 112 can include one or more labels 206. The one or more labels 206 can provide a reference so that the user can ensure that the shutoff valve is in the desired state (i.e., open or closed) based on the position of the pointer 204 relative to the one or more labels 206. For example, the one or more labels 206 can include “on” and “off” of “open” and “shut”, etc.

FIG. 2 additionally shows that the flow indicator 112 can include an indicator post 208. The indicator post 208 can allow for inspection farther from the backflow prevention device 100. I.e., the user must generally be close to see the flow display 202 and/or the one or more labels 206. In contrast, the indicator post 208 can be seen from a great distance. The indicator post 208 can be oriented vertically when flow is occurring in a horizontally installed backflow prevention device and can be oriented horizontally when flow is not occurring in a horizontally installed backflow prevention device. This matches current tradition where a gate valve indicating post is raised when flow is occurring. Thus, inspectors do not have to learn a new convention for visual inspection.

One of skill in the art will appreciate that the indicator post 208 may not be desirable in all locations. For example, in confined spaces no indicator post 208 or a smaller indicator post 208 may be desired. Thus, the indicator post 208 may be removable. For example, the indicator post 208 can include a hollow end that includes internal threads, allowing the indicator post 208 to be threaded or bolted onto the flow display 202. Additionally or alternatively, the indicator post 208 can be made of a flexible material, such as rubber, to prevent damage to the indicator post 208 during use or if contact with the indicator post 208 occurs.

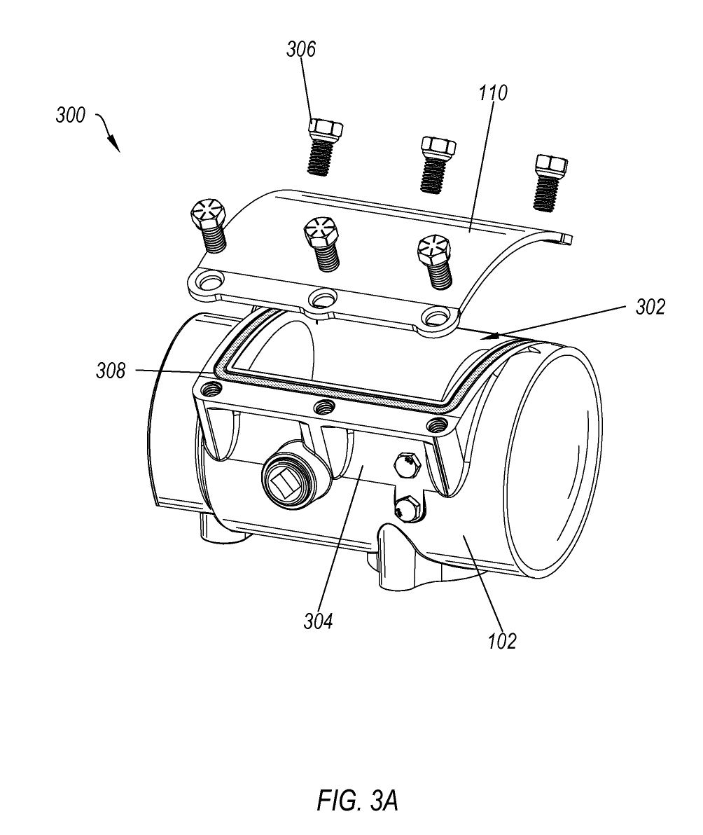

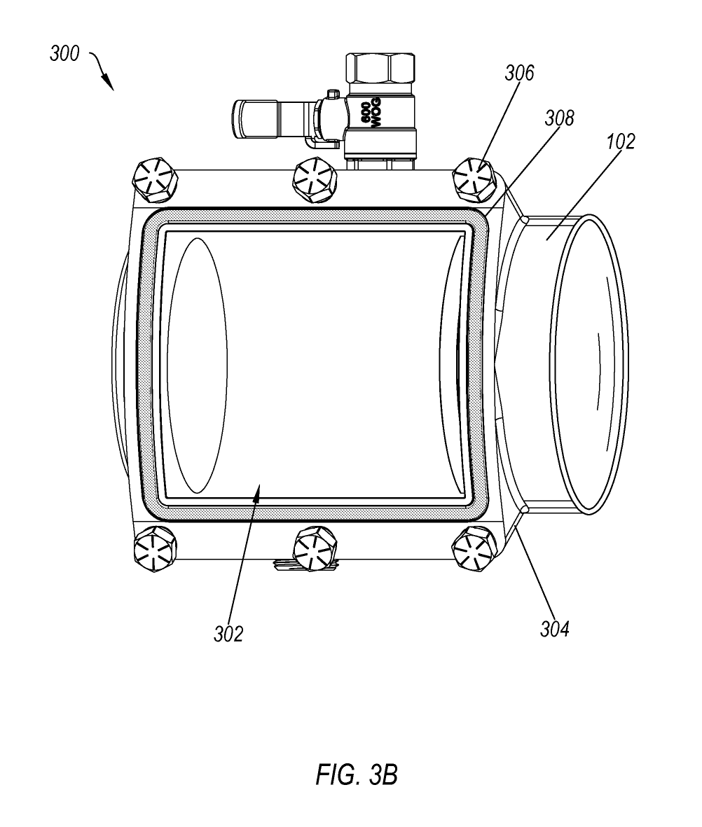

FIGS. 3A and 3B (collectively “FIG. 3”) illustrate an opening 300 of the backflow prevention device 100. FIG. 3A illustrates an exploded top perspective view of the opening 300 of the backflow prevention device; and FIG. 3B illustrates a top view of the opening 300 of the backflow prevention device without the cover 110. The opening 300 can allow a user to access the internal components of the backflow prevention device 100. I.e., the opening 300 can allow the user to access portions of the butterfly valves 108 which are normally not inline accessible, or to access check valve modules, either to ensure proper operation or to perform maintenance.

FIG. 3 shows that the opening 300 can include an access port 302. The access port can include a segment of the housing 102 which is open. I.e., a portion of the housing 102 can be missing, forming the access port 302. The access port 302 can allow the removal or insertion of components of the backflow prevention device or can allow the components to be checked or maintained. For example, the access port 302 can be a similar width as the housing 102. I.e., the access port 302 can include a portion of a half cylinder of the housing 102 which is not present.

FIG. 3 also shows that the opening 300 can include a cover mount 304. The cover mount 304 can allow a cover to be attached, as described below. In particular, the cover mount 304 can form or be proximate to the sides of the access port 302. I.e., the cover mount 304 can be located at antipodal points along the housing 102 near the access port 302. An antipodal point of a point on the surface of a circle is the point which is diametrically opposite to it—so situated that a line drawn from the one to the other passes through the center of the circle and forms a true diameter.

FIG. 3 further shows that the opening 300 can include a cover 110. The cover 110 has a bend or curvature to it, with the radius of curvature being larger than the radius of curvature of the housing 102 at the opening 300. One of skill in the art will appreciate that adding curvature to the cover 110 creates tangential tensile stresses when under pressure rather than bending moment stresses, typical of flat covers of similar purpose. I.e., the convex nature of the cover 110 allows the cover 110 to equalize the pressure over the entire surface, allowing the cover 110 to be thinner than if the cover 110 were flat. That is, a flat cover 110 would deform, to some degree, under pressure. In contrast, the curvature reduces the deformation of the cover 110. Additionally or alternatively, the force imparted by the water within the housing is less likely to cause separation of the cover 110 from the housing 102.

FIG. 3 additionally shows that the opening 300 can include an attachment 306. The attachment 306 is configured to attach the cover 110 to the cover mount 304. For example, the attachment 306 can include bolts, screws, clips, clamps or any other desired attachment. One of skill in the art will appreciate that the attachment 306 can be secured along the edges of the cover 110. I.e., no support structure is necessary within the access port 302, allowing a user to more easily access the interior portions of the backflow prevention device 100. One of skill in the art will further appreciate that the curvature of the cover 110 allows the cover 110 to cover a longer distance without requiring the thickness of a flat cover. That is, the same thickness of cover 110 can have a longer distance between attachments 306 because of the curvature of cover 110 relative to a flat cover 110.

FIG. 3 moreover shows that the opening 300 can include a seal 308. The seal 308 can sealingly engage the cover 110 and the housing 102 along the perimeter of the cover 110. That is, the seal 308 can provide a water tight connection between the cover 110 and the housing 112 when the cover is attached such that water is prevented from leaking out the cover 110 when water flows through the housing 102. For example, the seal 308 can include an elastomer or other compressible material.

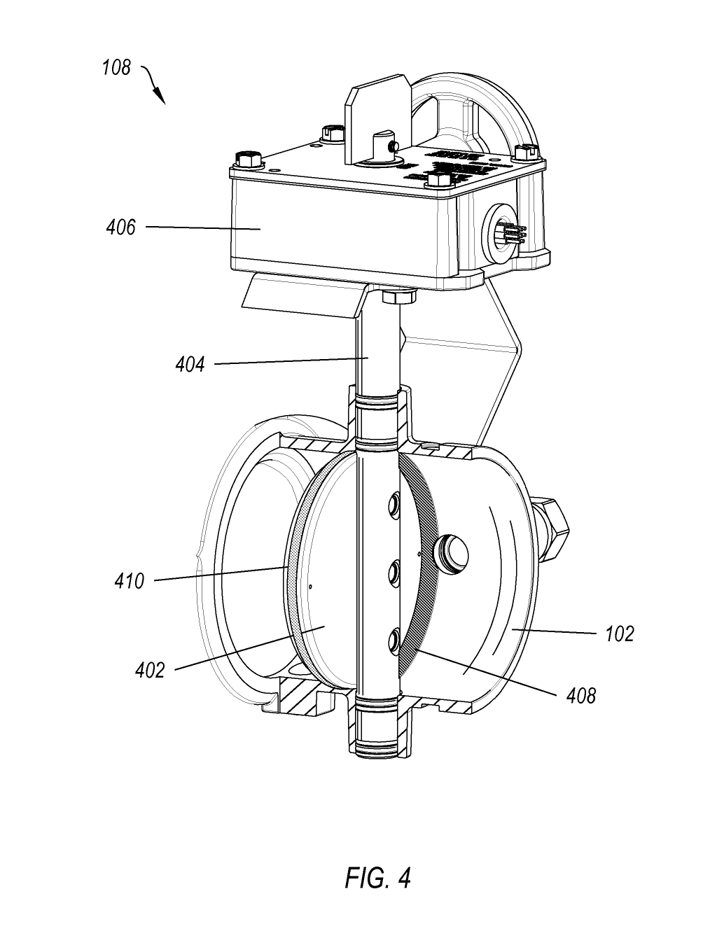

FIG. 4 illustrates an example of a butterfly valve 108. The butterfly valve 108 can prevent all fluid flow. That is, the butterfly valve 108 can form a seal with the housing 102 preventing all water flow through the shutoff valve. For example, the butterfly valve 108 can be used to test the backflow prevention device or to perform maintenance on the backflow prevention device.

FIG. 4 also shows that the butterfly valve 108 can include an obstruction 402. The obstruction 402 can be configured to mate with the internal surface of the housing 102. I.e., the obstruction 402 can be placed perpendicular to the flow when desired, preventing flow within the housing 102. In contrast, when the obstruction 402 is aligned parallel to the flow, the water can flow freely through the housing 102. For example, the obstruction 402 can include a disk or otherwise be shaped to match the internal shape of the housing 102.

FIG. 4 shows that the butterfly valve 108 can include a rotating means 404. The rotating means 404 can connect the obstruction 402 to a knob 406 or control. I.e., a user can use the knob 406 to move the rotating means 404, which moves the obstruction 402 into the desired position. That is, rotation of the rotating means 404 results in rotation of the obstruction 402. For example, the rotating means 404 can include a shaft or other device.

FIG. 4 further shows that the housing 102 can include a sealing surface 408. The sealing surface 408 can be a section of the housing 102 which is configured to receive the obstruction 402 in the closed position.

FIG. 4 additionally shows that the obstruction 402 can include a seal 410. The seal 410 can be configured to ensure drip tight mating between the obstruction 402 and the seat 408. I.e., the seal 410 can ensure that water does not leak past the obstruction 402 when in the closed position. For example, the seal 410 can include an O-ring or other compressible material.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A backflow prevention device, the backflow prevention device comprising:
a housing defining a water flow stream, wherein the housing includes:
an inlet configured to connect to a water supply; and
an outlet configured to connect to a system that uses water;
an upstream butterfly valve configured to allow a user to control the water flow stream through the housing;
an upstream indicator post, wherein the upstream indicator post:
is substantially parallel to the water flow if the upstream butterfly valve is closed; and
is substantially perpendicular to the water flow if the upstream butterfly valve is open;
a downstream butterfly valve configured to allow a user to control the water flow stream through the housing;
a downstream indicator post, wherein the downstream indicator post:
is substantially parallel to the water flow if the downstream butterfly valve is closed; and
is substantially perpendicular to the water flow if the downstream butterfly valve is open; and
a pair of check modules located between the upstream butterfly valve and downstream butterfly valve.

2. The backflow prevention device of claim 1, wherein the flow indicator includes a flow display configured to show the current direction of fluid flow.

3. The backflow prevention device of claim 2, wherein the flow display includes a pointer which points the current direction of fluid flow.

4. The backflow prevention device of claim 1, wherein the flow indicator includes one or more labels.

5. The backflow prevention device of claim 4, wherein the one or more labels include the word shut.

6. The backflow prevention device of claim 4, wherein the one or more labels include the word open.

7. The shutoff valve of claim 1, wherein the indicator post is removable from the backflow prevention device.

8. The backflow prevention device of claim 7, wherein attachment between the indicator post and the backflow prevention device includes a threaded connection.

9. The backflow prevention device of claim 1 further comprising an access port in the housing located between the upstream butterfly valve and downstream butterfly valve configured to provide a user with inline access to the internal components of the upstream butterfly valve and/or the downstream butterfly valve.

10. A backflow prevention device, configured such that the flow stream is oriented approximately horizontally, the backflow prevention device comprising:
a housing defining a water flow stream, wherein the housing includes:
an inlet configured to connect to a water supply; and
an outlet configured to connect to system that uses water;
an upstream butterfly valve configured to allow a user to control the water flow stream through the housing;
an upstream indicator post, wherein the upstream indicator post:
is approximately horizontal when the upstream butterfly valve is closed; and
is approximately vertical when the upstream butterfly valve is open;
a downstream butterfly valve
configured to allow a user to control the water flow stream through the housing;
a downstream indicator post, wherein the downstream indicator post:
is oriented approximately horizontal when the downstream butterfly valve is closed; and
is oriented approximately vertical when the downstream butterfly valve is open; and
a pair of check modules located between the upstream butterfly valve and downstream butterfly valve.

11. The backflow prevention device of claim 10 further comprising an access port in the housing located between the upstream butterfly valve and downstream butterfly valve configured to provide a user with inline access to the internal components of upstream butterfly valve and/or the downstream butterfly valve.

12. The backflow prevention device of claim 10, in which the housing is an assembly of more than one component.

13. The backflow prevention device of claim 10, in which housing is a single component.

14. A backflow prevention device, configured such that the flow stream is oriented approximately horizontally, the backflow prevention device comprising:
a housing defining a water flow stream, wherein the housing includes:
an inlet connected to a water supply; and
an outlet connected to system that uses water;
an upstream butterfly valve, wherein the upstream butterfly valve:
is configured to allow a user to control the water flow stream through the housing; and
includes a disk, wherein the disk:
is configured to:
prevent water flow at a first position;
allow water flow at a second position; and
rotate about an axis of rotation between the first position and the second position; and
includes:
a seal, wherein the seal is configured to sealingly engage
a sealing surface in the housing at the first position; and
an upstream indicator post, wherein the upstream indicator post:
is approximately horizontal when the upstream butterfly valve is closed; and
is approximately vertical when the upstream butterfly valve is open;
a downstream butterfly valve, wherein the downstream butterfly valve:
is configured to allow a user to control the water flow stream through the housing; and
includes a disk, wherein the disk:
is configured to:
prevent water flow at a first position;
allow water flow at a second position; and
rotate about an axis of rotation between the first position and the second position; and
includes:
a seal, wherein the seal is configured to sealingly engage
a sealing surface in the housing at the first position; and
a downstream indicator post, wherein the downstream indicator post:
is approximately horizontal when the downstream butterfly valve is closed; and
is approximately vertical when the downstream butterfly valve is open;
an access port in the housing configured to provide a user with access to the upstream butterfly valve disk and the downstream butterfly valve disk; and
a pair of check modules located between the upstream butterfly valve and downstream butterfly valve.

15. The backflow prevention device of claim 14, further comprising a cover configured to cover the entirety of the access port.

16. The backflow prevention device of claim 15 further comprising a mount configured to secure the cover to the housing.

17. The shutoff valve of claim 15, wherein the cover is secured to the mount along the edges of the cover.

18. The backflow prevention device of claim 15, wherein the cover is secured via a bolt.

19. The backflow prevention device of claim 15, further comprising:
a seal configured to sealingly engage the cover and the housing along the perimeter of the cover.
